(19) United States
(12) Patent Application Publication
(10) Pub. No.: US 2020/0022867 A1
(43) Pub. Date: Jan. 23, 2020

(54) TREATMENT UNIT AND MASSAGE MACHINE USING TREATMENT UNIT

(71) Applicant: FAMILY INADA CO., LTD., Osaka (JP)

(72) Inventors: Nichimu Inada, Osaka (JP); Yoshifumi Fukuyama, Tottori (JP); Soma Kanazawa, Tottori (JP)

(21) Appl. No.: 16/519,662

(22) Filed: Jul. 23, 2019

(30) Foreign Application Priority Data
Jul. 23, 2018 (JP) 2018-137955

(51) Int. Cl. A61H 15/00; A61H 7/00

(52) U.S. Cl. CPC A61H 15/0078; A61H 7/007; A61H 2201/0149; A61H 2015/005; A61H 2201/1654; A61H 2201/1661; A61H 2205/106; A61H 2201/1427; A61H 2201/1671; A61H 2205/081; A61H 2205/086; A61H 2205/108; A61H 2201/1418

(57) ABSTRACT

A treatment unit includes a treatment element configured to press a person to be treated; a treatment part that includes the treatment element; an output shaft that drives the treatment part; a drive part configured to rotate the output shaft; and a swash plate eccentric cam that rotates integrally with the output shaft. The treatment part oscillates in a direction along a direction of an axis of rotation of the output shaft and a direction intersecting the direction of the axis without rotating along with rotation of the swash plate eccentric cam.

### TECHNICAL FIELD

The present invention relates to a treatment unit and a massage machine using the treatment unit.

### BACKGROUND ART

Japanese Unexamined Patent Application Publication No. 2015-211718 (hereinafter referred to as “JP-2015-211718-A”) discloses a massage device (one aspect of a treatment unit) having a motor, a drive shaft which is rotated by driving of the motor, and a pair of arms supported on the drive shaft and moving toward each other and away from each other with the rotation of the drive shaft. In this massage device, if the drive shaft rotates, front portions of the arms move toward each other and away from each other or rear portions move toward each other and away from each other, whereby it is possible to perform a mechanical massaging motion on a portion to be treated.

### SUMMARY OF THE INVENTION

In the massage device disclosed in JP-2015-211718-A, a massage imitating a massaging motion with the hand of a person is possible. However, a motion that further imitates a movement of the wrist or the elbow of the arm of a person, such as gripping and twisting, cannot be performed.

The treatment unit of the present invention includes a treatment element configured to press a person to be treated; a treatment part that includes the treatment element; an output shaft that drives the treatment part; a drive part configured to rotate the output shaft; and a swash plate eccentric cam that rotates integrally with the output shaft. The treatment part oscillates in a direction along a direction of an axis of rotation of the output shaft and a direction intersecting the direction of the axis without rotating along with rotation of the swash plate eccentric cam.

The treatment part may include a support part that includes a plate surface, the support part supports the treatment element. The treatment element may include an air cell that expands and contracts at least in a direction intersecting the plate surface according to supply and discharge of a fluid, the air cell is supported on the plate surface.

The treatment unit may include two or more treatment elements. In this case, each of the treatment elements may individually include the air cell. The air cell may include an independent supply and discharge port for the fluid. Each of the air cells can independently expand and contract.

The invention of this application relates to a massage machine that includes: a pair of the treatment units. The pair of the treatment units can be disposed symmetrically in right and left so as to be suitable for treatment on right and left sides of a body of the person to be treated.

The massage machine may include a seat part that includes a seat surface for the person to be treated. The seat part may include an accommodation chamber provided below the seat surface. The drive part of each of the pair of treatment units may be accommodated in the accommodation chamber. The treatment element of each of the pair of treatment units may be disposed at a position where treatment can be performed on at least a part on an outer side of a buttock and a thigh of the person to be treated seated on the seat part on an upper side of the seat surface.

The seat part may include a seat surface lifting part configured to lift and lower a part of the seat surface provided between the pair of treatment units. The seat part may include a seat surface support part that supports the seat surface provided between the pair of treatment units at a lower side. In this case, the seat surface lifting part may include at least a pair of right and left lifting cells, each of the lifting cells includes a lifting end portion which is lifted and lowered in a direction intersecting the seat surface, and a fixed end portion. The lifting end portions may be disposed on right and left inner sides of the pair of right and left lifting cells.

### BRIEF DESCRIPTION OF THE DRAWINGS

FIG. 1 is a perspective view showing the overall configuration of a massage machine.

FIG. 2 is a perspective view showing the overall configuration of a seat part unit, as viewed from the right front side.

FIG. 3 is a sectional view of the seat part unit.

FIG. 4 is a perspective view showing the overall configuration of the seat part unit, as viewed from the left rear side.

FIG. 5 is a view of the seat part unit as viewed from the front.

FIG. 6 is a top view of an internal structure of a seat part.

FIG. 7 is a top view of the seat part.

FIG. 8 is an explanatory view of the internal structure of the seat part as viewed from the front.

FIG. 9 is a front view of the seat part unit in a first state.

FIG. 10 is a front view of the seat part unit in a second state.

FIG. 11 is a front view of the seat part unit in a third state.

FIG. 12 is a front view of the seat part unit in a fourth state.

FIG. 13 is a top view of the seat part unit in the first state.

FIG. 14 is a top view of the seat part unit in the second state.

FIG. 15 is a top view of the seat part unit in the third state.

FIG. 16 is a top view of the seat part unit in the fourth state.

FIG. 17 is a perspective view of the massage machine showing a state where a back part unit, a leg part unit, and a foot part unit are mounted.

### DESCRIPTION OF THE INVENTION

A treatment unit according to a feature of the present invention for achieving the above object includes at least one or two or more treatment elements for pressing a person to be treated, a treatment part having the treatment elements, an output shaft which drives the treatment part, a drive part which rotates the output shaft, and a swash plate eccentric cam which rotates integrally with the output shaft, in which the treatment part oscillates in a direction along a direction of an axis of rotation of the output shaft and a direction intersecting the direction of the axis without rotating with rotation of the swash plate eccentric cam.

According to the above configuration, the treatment part having the treatment elements is driven by the drive part which rotates the output shaft, and presses and treats a portion to be treated of the person to be treated with the treatment elements by the driving. At the time of this treatment, the treatment element can press the portion to be treated of the person to be treated while oscillating in the direction along the direction of the axis and the direction intersecting the direction of the axis. In this way, the treatment part can treat the person to be treated by applying a massaging motion and a twisting motion imitating the movement of the wrist and the elbow of a person when the treatment element is regarded as the finger of a person. Further, the two or more treatment elements can perform a motion corresponding to each of the fingers of a treatment person. Therefore, a feeling of treatment is improved.

The treatment unit according to the the present invention has a further feature that the treatment part has a support part having a plate surface for supporting the treatment element and the treatment element has an air cell which expands and contracts at least in a direction intersecting the plate surface due to supply and discharge of a fluid and is supported on the plate surface.

According to the above configuration, while the support part performs a gripping motion and a twisting motion imitating the movement of the wrist and the elbow of a person corresponding to the palm and the back of the hand of a person by the oscillation motion of the treatment part, the treatment element can perform treatment by imitating a movement corresponding to a gripping motion by the four fingers of a person by the expansion and contraction operation of the air cell. In this way, a feeling of treatment is improved.

The treatment unit according to the present invention has a further feature that each of the treatment elements individually has the air cell, two or more of the air cells each have an independent supply and discharge port for the fluid, and each of the two or more air cells can independently expand and contract.

According to the above configuration, each of the air cells of the two or more treatment elements has an independent supply and discharge port for the fluid and can independently expand and contract, whereby each air cell can operate independently. Further, each of the two or more treatment elements has the air cell that can operate independently, whereby each treatment element can perform a motion corresponding to each of the fingers of a treatment person. In this way, a feeling of treatment is improved.

A massage machine according to the present invention for achieving the above object includes a pair of the treatment units, in which the pair of treatment units are disposed symmetrically in right and left so as to be suitable for treatment on right and left sides of a body of the person to be treated.

According to the above configuration, the treatment units are disposed in a pair on the right and left sides, whereby treatment can be performed from the right and left sides of the body of the person to be treated. Since the treatment units have the independent drive parts, right and left independent operations are possible.

The massage machine according to a feature of the present invention has a further feature that the massage machine further includes a seat part having a seat surface suitable for seating of the person to be treated, the seat part has an accommodation chamber provided below the seat surface, the drive part of each of the pair of treatment units is accommodated in the accommodation chamber, and the treatment element of each of the pair of treatment units is disposed at a position where treatment can be performed on at least a part on an outer side of a buttock and a thigh of the person to be treated seated on the seat part on an upper side of the seat surface.

According to the above configuration, it is possible to treat the buttock and the thigh of the person to be treated seated on the seat surface by the treatment elements. The drive part is accommodated in the accommodation chamber, whereby the person to be treated and the drive part are isolated from each other, and thus it is possible to secure security.

The massage machine according to the present invention has a further feature that the seat part has a seat surface lifting part for lifting and lowering a part of the seat surface provided between the pair of treatment units and a seat surface support part for supporting the seat surface provided between the pair of treatment units at a lower side.

According to the above configuration, the seat surface lifting part is regarded as the thumb of a treatment person and the treatment elements are regarded as the four fingers of the treatment person, whereby treatment such as pinching the buttock and the thigh of the person to be treated with the thumb and the four fingers of the treatment person can be realized by the seat surface lifting part and the treatment elements. Further, the seat surface is supported from below by the seat surface support part, and the seat surface support part receives most of the weight of the person to be treated seated on the seat surface. Therefore, when treatment is performed by the seat surface lifting part and the treatment elements, since the entire weight of the person to be treated is not applied to the treatment unit, a load of the drive part of the treatment unit can be reduced.

The massage machine according to the present invention has a further feature that the seat surface lifting part has at least a pair of right and left lifting cells each having a lifting end portion which is lifted and lowered in a direction intersecting the seat surface, and a fixed end portion, and the lifting end portions are disposed on right and left inner sides of the pair of right and left lifting cells.

According to the above configuration, the lifting end portion of each of the pair of right and left lifting cells rises, whereby the right and left buttocks and thighs of the person to be treated can be pressed toward the right and left outer sides from the right and left inner sides by the lifting cells of the seat surface lifting part. In this way, treatment such as pinching the right and left buttocks and thighs of the person to be treated between the inner side and the outer side by the right and left lifting cells of the seat surface lifting part and the treatment elements can be realized.

The massage machine according to the present invention has a further feature that the massage machine further includes a backrest part having a backrest surface suitable for placing a back of the person to be treated thereon and the treatment element treats a back portion or a waist portion of the person to be treated on a front side of the backrest surface.

According to the above configuration, it is possible to treat the back portion or the waist portion. The drive part is disposed on the back surface side of the backrest surface, whereby the person to be treated and the drive part is isolated from each other, and thus it is possible to secure security.

The massage machine according to the present invention has a further feature that the massage machine further includes a footrest having a groove portion suitable for putting a lower thigh of the person to be treated therein and the treatment element treats a calf of the person to be treated from a side of the groove portion.

According to the above configuration, it is possible to treat the calf of the person to be treated in a state where the lower thigh of the person to be treated is put in the groove portion of the footrest by being fitted to the groove portion, or the like.

The massage machine according to the present invention has a further feature that the massage machine further includes a footrest having a footboard portion suitable for placing a foot of the person to be treated thereon and the treatment element treats a side portion of a foot of the person to be treated on an upper side of the footboard portion.

According to the above configuration, it is possible to treat the side portion of the foot of the person to be treated in a state where the foot of the person to be treated is placed on the footboard portion of the footrest.

The massage machine according to the present invention has a further feature that the drive part of each of the pair of treatment units is operable asynchronously.

According to the above configuration, the pair of treatment units can perform treatment asynchronously with each other. For example, by intensively treating one side of the body of the person to be treated by driving only one of the pair of treatment units, or by changing a balance between driving times or the timings of driving of the treatment units, it becomes possible to perform treatment according to the level of tiredness of the body of the person to be treated or a wish of the person to be treated.

The massage machine according to the present invention has a further feature that the drive part of each of the pair of treatment units has an independent motor.

According to the above configuration, the pair of treatment units can perform treatment independent of each other with each independent motor as a drive source. For example, by intensively treating one side of the body of the person to be treated by driving only one of the pair of treatment units, or by changing a balance between driving times or the timings of driving of the treatment units, it becomes possible to perform treatment according to the level of tiredness of the body of the person to be treated or a wish of the person to be treated.

Further, each drive part has an independent motor, whereby it is possible to reduce the required power of the drive part per one and to downsize the drive part. Further, it is possible to omit a rotational power transmission mechanism such as a shaft for transmitting rotational power between the pair of treatment units. In this way, it becomes possible to realize downsizing of the massage machine.

According to the above configuration, it is possible to provide a treatment unit and a massage machine, which realize treatment with a twisting motion added thereto.

### EMBODIMENTS

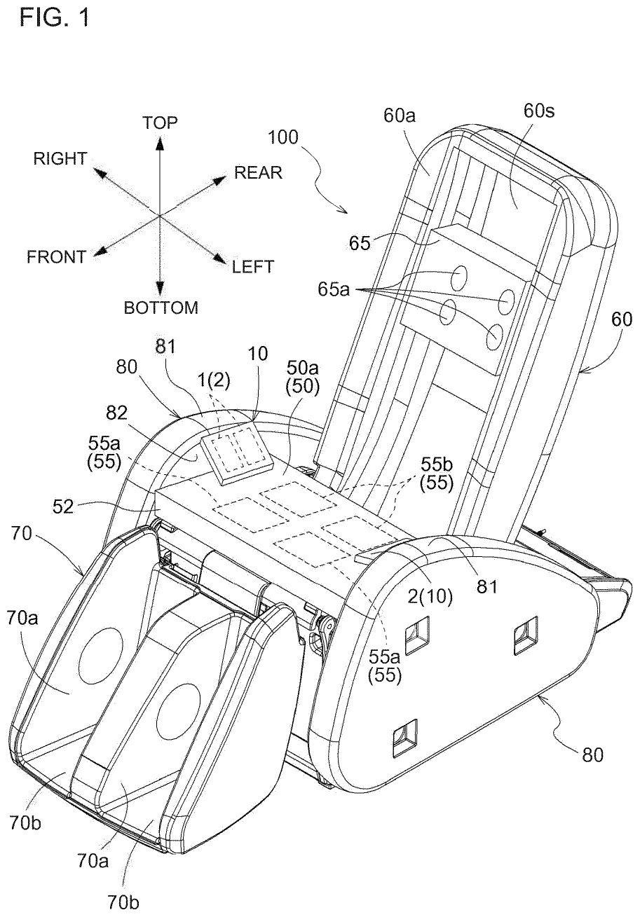

A treatment unit and a massage machine according to an embodiment of the present invention will be described based on FIGS. 1 to 17.

### Overall Configuration of Massage Machine

FIG. 1 shows the overall structure of a massage machine 100 according to this embodiment. The massage machine 100 is a massage chair having at least one pair of seat part units 10, each of which is an example of a treatment unit according to this embodiment, provided at the right and left of a seat part 50.

The massage machine 100 of this embodiment includes members such as the seat part 50 having a seat surface 50a suitable for seating of a person to be treated (in the following, there is a case where the person to be treated is simply referred to as a person), a backrest part 60 having a backrest surface 60a suitable for leaning of the back of the person thereon, a footrest 70 having a pair of right and left groove portions 70a suitable for putting the lower legs of the person therein and a pair of right and left footboard portions 70b suitable for placing the feet of the person thereon, and an armrest part 80 having an armrest 81 suitable for placing the arm of the person thereon and a plate surface 82 suitable for supporting the side surface of the body of the person toward the inside of the seat part when the person has been seated on the seat surface 50a, and the like. The massage machine 100 shown in FIG. 1 is illustrated with a lining of a device surface omitted. However, the above members and the like are covered with a lining having a design property and a comfortable touch surface when the skin of a person comes into contact with it.

In the following, directions will be described with the front side in a case where a person is seated on the seat surface 50a defined as the front, the back side defined as the rear, the right-hand side defined as the right, the left-hand side defined as the left, and the upper and lower sides in a vertical direction defined as the top and bottom. Further, in a case of being mentioned simply as an inner side or an outer side, the inner side will be described as being an inner side in the right-left direction of particularly the seat part 50 and the side opposite thereto as being an outer side.

In the massage machine 100, the footrest 70, the seat part 50, and the backrest part 60 are disposed from the front toward the rear. The groove portions 70a of the footrest 70 extend downward when viewed from the seat surface 50a.

A lower end of the backrest part 60 is fixed so as to be rotatable in an up-down direction at a rear end of the seat part 50, and the backrest part 60 can be reclined. A massaging ball unit 65 which moves up and down along the backrest surface 60a is provided on the inner side in the right-left direction of the backrest surface 60a of the backrest part 60. The massaging ball unit 65 has, for example, four massaging balls 65a. The massaging ball unit 65 treats the back portion of a person with the massaging balls 65a while moving up and down along the backrest surface 60a.

The armrest parts 80 are fixed to the right and left side surfaces of the seat part 50, and the armrest parts 80 extend further toward the upper side than the seat surface 50a. Treatment parts 2 of the seat part units 10 are disposed at both end portions in the right-left direction on the seat surface 50a with a four-finger part 1 (an example of a treatment element) of each treatment part 2 facing inward. The pair of right and left seat part units 10 are plane-symmetrical to each other.

### Overall Configuration of Seat Part Unit

In the following, the seat part unit 10 on the left side out of the pair of right and left seat part units 10 will be described. Since the seat part unit 10 on the right side is plane-symmetrical to the seat part unit 10 on the left side, description thereof is omitted. In the following, the seat part unit 10 on the left side will be simply referred to as the seat part unit 10.

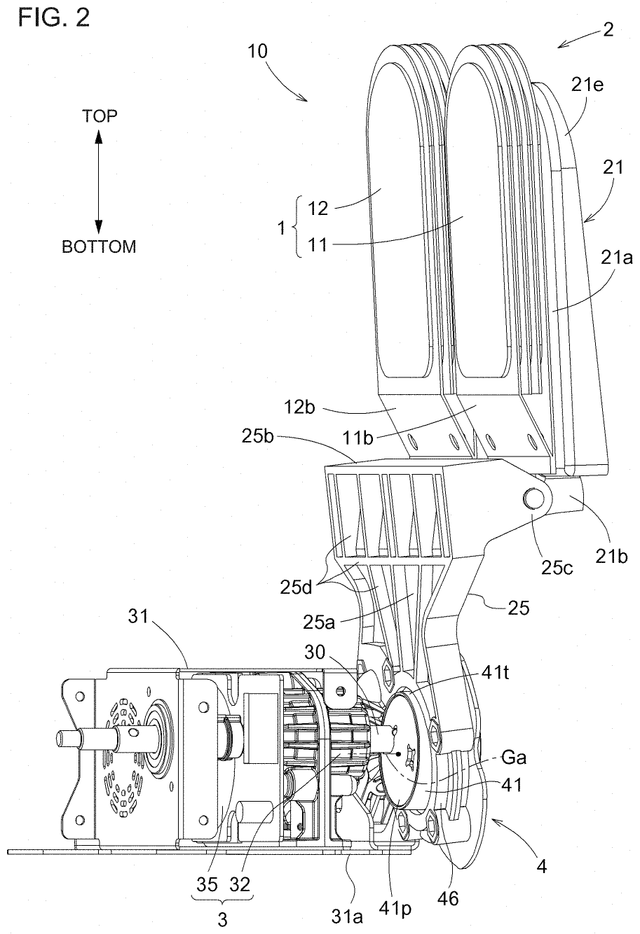

As shown in FIG. 2, the seat part unit 10 includes the treatment part 2 having the four-finger part 1 (an example of the treatment element) suitable for treating the body of a person with pressing or the like, a drive part 3 having an output shaft 30 for driving the treatment part 2 and rotating the output shaft 30, a cam 4 (an example of a swash plate eccentric cam) which rotates integrally with the output shaft 30, a casing 31 which accommodates the drive part 3 and the like, and the like.

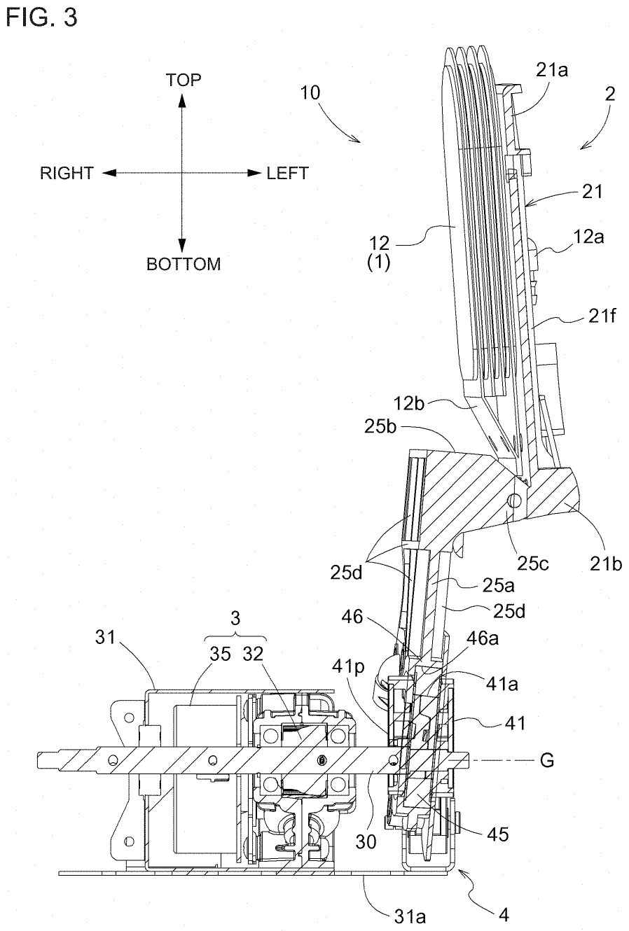

As shown in FIGS. 2 and 3, and the like, the drive part 3 has a motor 35 which generates rotational power, a speed reducer 32 which converts the rotational power of the motor 35 into a predetermined rotational speed (a rotational frequency per unit time) and torque, the output shaft 30 for the rotational power of the speed reducer 32, a circuit board for supply or the like of electric power to the motor 35, and the like. A constituent element such as the motor 35 or the speed reducer 32 of the drive part 3 is accommodated in the casing 31. FIG. 3 is a front view of a cross section parallel to the up-down direction passing through a rotation axis G of the output shaft 30.

In the output shaft 30, as shown in FIG. 3, the rotation axis G which is an axis of rotation of the output shaft 30 is provided along the right-left direction. The cam 4 is mounted to an end portion on the left side in the right-left direction of the output shaft 30. The output shaft 30 rotates in proportion to the rotational speed of the motor 35. The output shaft 30 rotates, for example, in a clockwise direction in a case of being viewed from the left side.

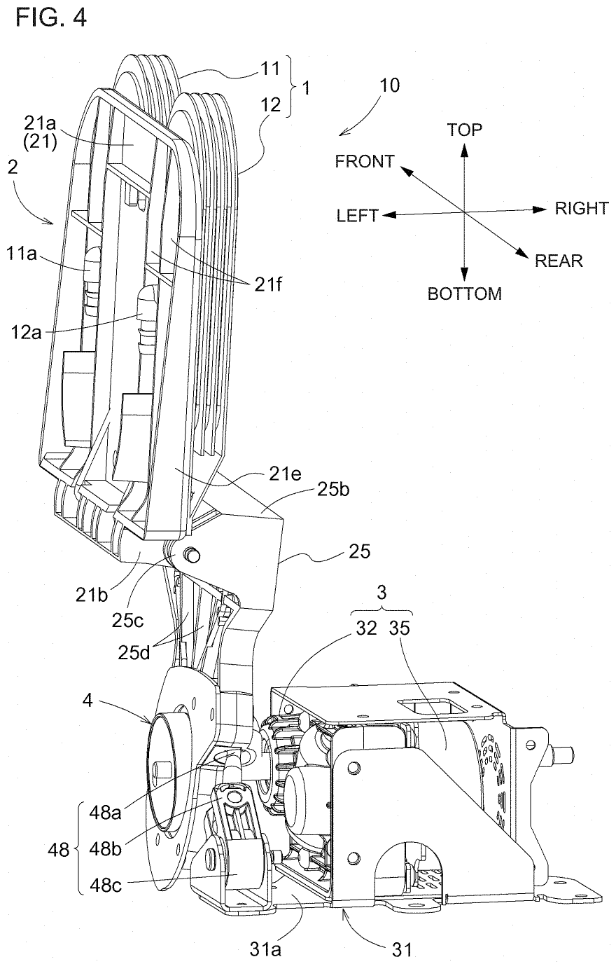

The cam 4 is a swash plate eccentric cam. As shown in FIG. 3, the cam 4 has a ball bearing 45 which is an annular bearing, a resin-made cam main body 41 having a groove which is fitted to an inner ring of the ball bearing 45 and rotating integrally with the inner ring of the ball bearing 45, a transmission plate holding part 46 having a groove 46a which is fitted to an outer ring of the ball bearing 45, and holding a transmission plate 25, and a link mechanism 48 (refer to FIG. 4) which restricts an operation range of the transmission plate holding part 46 with respect to a rotation direction of the cam main body 41 within a predetermined range such that the transmission plate holding part 46 does not rotate with the rotation of the cam main body 41 (the output shaft 30), and permits the movement of the transmission plate holding part 46 in an axial direction of the rotation axis G the output shaft 30.

As shown in FIG. 4, the link mechanism 48 has a spherical end portion 48a, a first joint 48b rotatable in the right-left direction, and a second joint 48c rotatable in the up-down direction. The end portion 48a is connected to the transmission plate holding part 46 by a spherical hole and ball joint method. The second joint 48c is pivotally supported on a support seat 31a extending outward from the casing 31.

As shown in FIG. 3, the ring of the ball bearing 45 and the axis of rotation of the ball bearing 45 are inclined with respect to both the rotation axis G and a virtual plane normal to the rotation axis G. In the following, these inclinations will be collectively referred to simply as an inclination of the cam 4. In this embodiment, the virtual plane normal to the rotation axis G corresponds to a right side surface 41p of the cam main body 41 (described later). The inner ring and the outer ring of the ball bearing 45 are located on the same rotation axis and can rotate relative to each other.

As shown in FIGS. 2 and 3, the cam main body 41 is an eccentric cam which is fixed to the output shaft 30 and rotates integrally with the output shaft 30. The cam main body 41 is formed in a columnar shape. As shown in FIG. 3, the right side surface 41p, which is the bottom surface on the right side of the column of the cam main body 41, perpendicularly intersects the rotation axis G. The cam main body 41 rotates around the same axis as the rotation axis G. An axis Ga of the column of the cam main body 41 is provided along the rotation axis G. The axis Ga does not overlap the rotation axis G in the right-left direction and is offset from the rotation axis G. A groove 41a which is fitted to the inner ring of the ball bearing 45 is formed on the outer periphery of the cam main body 41. The groove 41a is provided along the inclination of the cam 4.

As shown in FIG. 3, the transmission plate holding part 46 has the groove 46a which is fitted to the outer ring of the ball bearing 45, and rotates integrally with the outer ring of the ball bearing 45. The transmission plate holding part 46 oscillates in a direction along the rotation axis G and a direction intersecting the rotation axis G due to the rotation of the cam main body 41 rotating integrally with the output shaft 30 and the rotation relative to the outer ring of the ball bearing 45. In the following, the oscillation is simply referred to as oscillation of the cam 4. Details of the oscillation of the cam 4 will be described later.

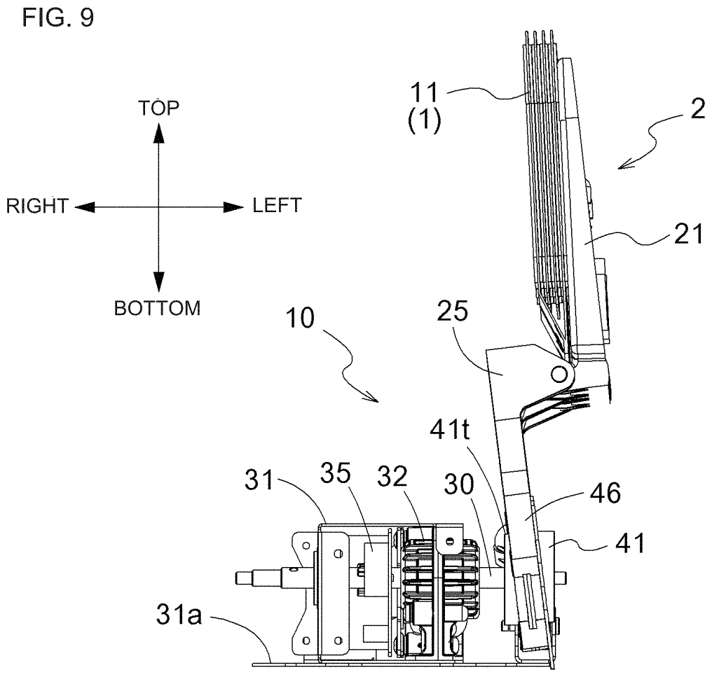

In the following, the outer periphery position of the cam main body 41, at which the groove 41a is located on the innermost side in the direction along the rotation axis G, will be referred to as a vertex 41t (refer to FIG. 9). Further, in the following, the major axis side when viewed from the rotation axis G, of the cam main body 41, will be simply referred to as the major axis side of the cam main body 41, and the direction toward the major axis side of the cam main body 41 when viewed from the rotation axis G will be referred to as a major axis direction.

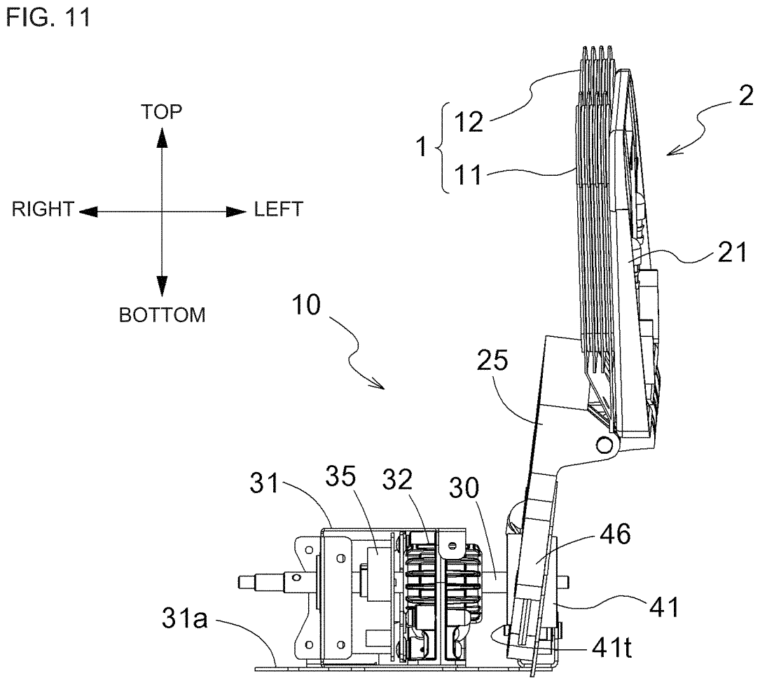

In this embodiment, in a case where the vertex 41t is located at the uppermost position, the major axis side of the cam main body 41 is located at the most front position (refer to FIG. 9). Further, in a case where the vertex 41t is located at the lowermost position, the major axis side of the cam main body 41 is located at the rearmost position (refer to FIG. 11).

The treatment part 2 is a unit which treats the body of a person with pressing or the like by oscillating in a predetermined oscillation range in the front-rear direction, the right-left direction, the up-down direction, and the like. As shown in FIGS. 2 to 4, the treatment part 2 has the four-finger part 1 which presses and treats the body of a person, a back plate 21 (an example of a support part) which supports the four-finger part 1, the transmission plate 25 having one end mounted to the cam 4 and the other end connected to the back plate 21, and an elastic member (not shown) such as a double torsion spring having a coil which generates a biasing force which biases the back plate 21 such that the upper end of the back plate 21 moves inward.

The transmission plate 25 is a plate-like member which connects the cam 4 and the treatment part 2. The transmission plate 25 transmits the oscillation of the cam 4 to the four-finger part 1. As shown in FIG. 3, the transmission plate 25 has a plate portion 25a which is fixed to the cam 4, and a pivot support portion 25b which pivotally supports the back plate 21. The transmission plate 25 is provided to extend upward from the cam 4.

The plate portion 25a is fixed to the left side surface of the transmission plate holding part 46 by bolts or the like. The plate portion 25a is mounted so as to intersect (in this embodiment, be orthogonal to) the rotation axis of the ball bearing 45. As shown in FIGS. 3 to 5, the plate portion 25a is reinforced by being provided with ribs 25d intersecting the plate surface of the plate portion 25a. The ribs 25d are provided on both right and left side surfaces of the plate portion 25a.

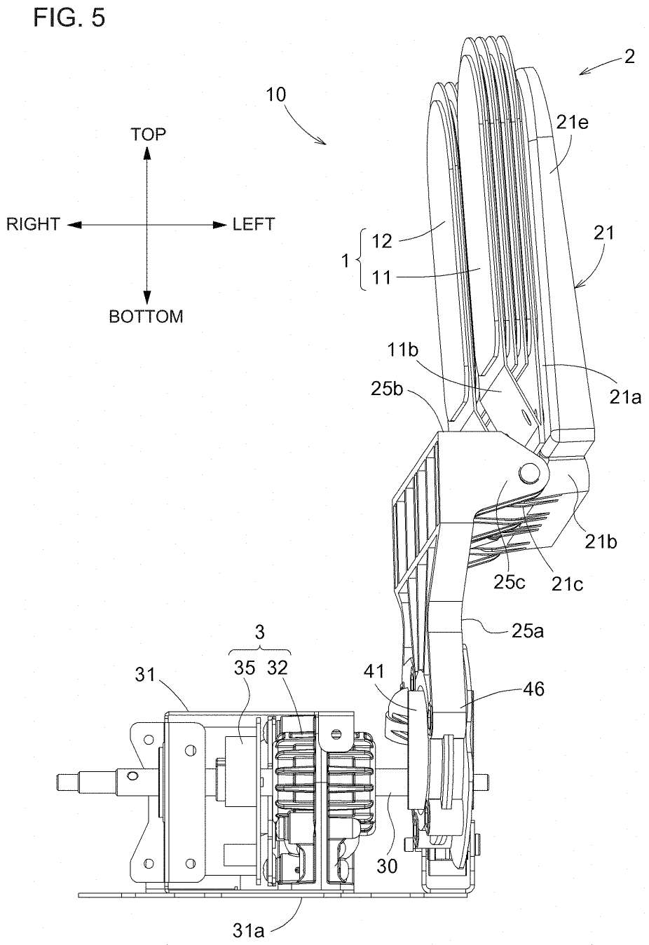

As shown in FIGS. 2 to 5, the pivot support portion 25b has a bearing portion 25c having a pair of shaft holes. The bearing portion 25c is rotatably connected to a bearing portion 21c (refer to FIG. 5) of the back plate 21 (described later). The shaft holes of the bearing portion 25c extend along the right-left direction in a state where the treatment part 2 is most inclined in the right direction.

As shown in FIG. 5, the back plate 21 has a plate portion 21a which supports the four-finger part 1, a pivot support portion 21b formed at a lower end of the plate portion 21a and connected to the transmission plate 25, and the bearing portion 21c formed at the pivot support portion 21b.

The plate portion 21a is a plate-like member in which a longitudinal direction thereof extends along the up-down direction. As shown in FIG. 3, the inner (right-side) surface (hereinafter referred to as the surface of the back plate 21) in the right-left direction of the plate portion 21a is formed in a flat plate shape. As shown in FIG. 4, the plate portion 21a has a rib 21e and a rib 21f which are provided to be erect so as to extend outward from the outer (left-side) surface in the right-left direction of the plate portion 21a. The plate portion 21a is reinforced by the ribs 21e and 21f. The rib 21e is provided along the outer periphery of the plate portion 21a. The rib 21f is provided on the inner side surrounded by the rib 21e. The plate portion 21a has a pair of through-holes (not shown) on the side of both side surfaces of the plate of the rib 21e.

The bearing portion 21c has a pair of shaft holes (not shown) arranged along the front-rear direction in a state where the treatment part 2 is most inclined in the right direction. The bearing portion 21c and the bearing portion 25c are rotatably connected to each other by a shaft pin or the like inserted into the respective shaft holes.

An example of the elastic member such as the double torsion spring described above will be described. Although illustration is omitted, for example, in a case where the double torsion spring is used as the elastic member, a double torsion spring having a pair of co-axial coils in the front-rear direction, an angulate U-shaped bridge portion bridging one ends of the pair of coils, and a pair of other end portions which is the other end side of the bridge portion with respect to the coil can be adopted. In this case, the double torsion spring is fixed by engaging the bridge portion with a hook (not shown) or the like provided in the treatment part 2. The pivot support portion 21b is provided with a plate surface or the like which intersects the rotation direction (hereinafter referred to as a rotation direction of the treatment part) in which the bearing portion 21c is rotated by being pivotally supported on the bearing portion 25c, and this is used as a spring holder. Then, the spring holders are mounted to a pair of end portions so as to bias the treatment part 2 along the rotation direction with the engaged portion as a supporting point such that the upper end of the back plate 21 moves inward.

The four-finger part 1 is a treatment element which presses and treats the body of a person. The four-finger part 1 performs treatment corresponding to the four fingers of a treatment person. As shown in FIGS. 3 and 4, the four-finger part 1 has cells 11 and 12 (each is an example of an air cell) which are two expansion and contraction bags fixed to the surface of the back plate 21. The cell 12 is an expansion and contraction bag on the rear side of the cell 11.

Each of the cells 11 and 12 is a bag having a bellows, which expands if it is supplied with a fluid such as air, and contracts if the fluid is discharged. Each of the cells 11 and 12 has a longitudinal direction when viewed from the front with respect to the surface of the back plate 21. The longitudinal direction of each of the cells 11 and 12 is along the up-down direction. The cells 11 and 12 press the body of a person by the expansion and contraction. The cells 11 and 12 respectively have independent supply and discharge ports 11a and 12a.

In the cells 11 and 12, folds of the bellows are provided in the direction along the surface of the back plate 21, and if a fluid is supplied from the supply and discharge port 11a or the supply and discharge port 12a, the cells 11 and 12 independently expand and contract in a direction intersecting the surface of the back plate 21 (a direction along the normal direction to the surface of the back plate).

A restricting portion 11b and a restricting portion 12b which restrict the expansion of the cell 11 and the cell 12 in the direction intersecting the surface of the back plate 21 are provided on the lower end side (the pivot support portion 21b side) in the longitudinal direction of the cell 11 and the cell 12, and the bellows are bundled. In this way, the lower end side of each of the cells 11 and 12 does not expand even if a fluid is supplied. The bellows can expand and contract on the upper end side compared to the lower end side, and the upper side greatly expands in the direction intersecting the surface of the back plate 21. Each of the cells 11 and 12 performs treatment corresponding to the fingers of a treatment person.

As shown in FIG. 4, the supply and discharge ports 11a and 12a are connection terminals for connecting a tube (not shown) for supplying and discharging a fluid. The supply and discharge ports 11a and 12a are pipes each having an opening. The supply and discharge ports 11a and 12a are provided on the surfaces on the side being in contact with the back plate 21, of the cells 11 and 12. The pipe portion of each of the supply and discharge ports 11a and 12a passes through the through-hole of the back plate 21, and the opening thereof is open in the surface on the side opposite to the surface of the back plate 21.

### Regarding Seat Part and Seat Surface Lifting Part

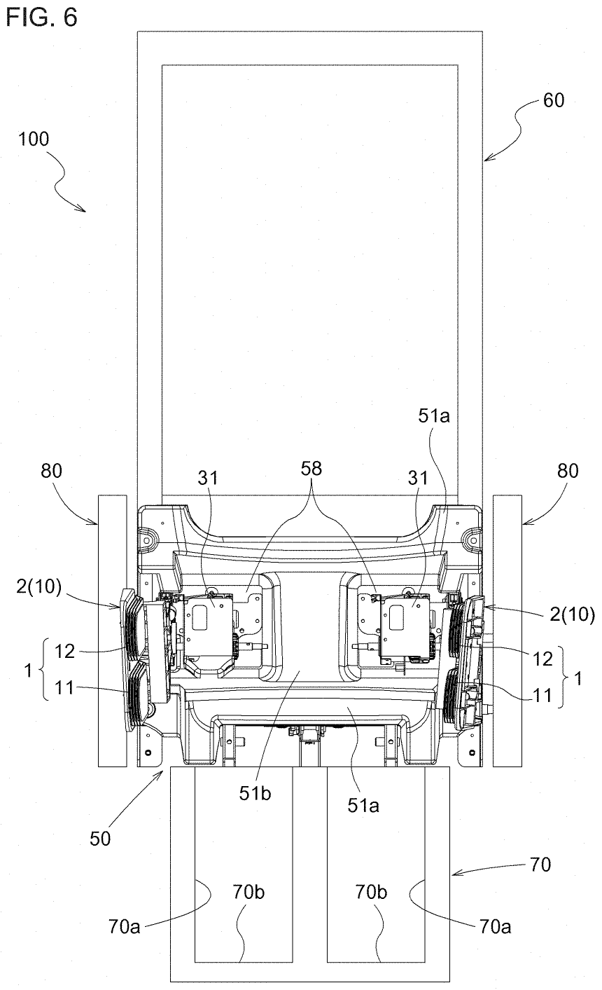

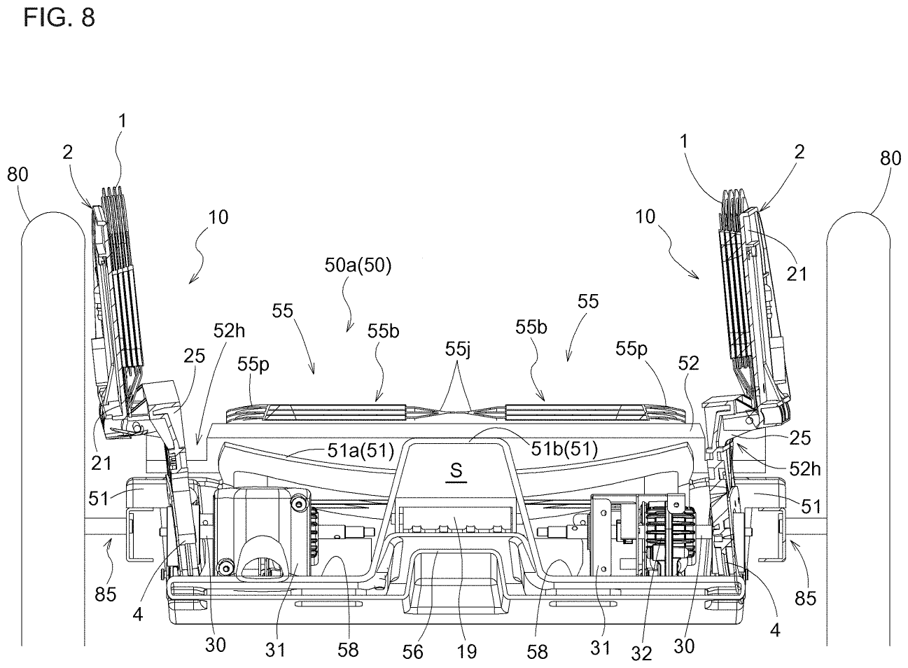

As shown in FIG. 8, the seat part 50 is a base portion suitable for seating of a person on the seat surface 50a thereof. Further, as shown in FIGS. 6 and 8, the seat part 50 is a base portion which separately accommodates and supports the pair of right and left seat part units 10. As shown in FIG. 8, the seat part 50 has a frame 51 which is a base portion, a seat part sheet 52 placed on the frame 51, and a pair of right and left seat surface lifting parts 55 (refer to FIGS. 1, 7, and 8) placed on the seat part sheet 52. The frame 51 is placed on a support frame 85 (refer to FIG. 8) extending inward in the right-left direction from the armrest part 80, and is fixedly supported on the pair of right and left armrest parts 80.

The frame 51 is a seat frame which supports a person seated on the seat surface 50a. The frame 51 has a first frame 51a which supports the outer peripheral portion of the seat surface 50a, and a second frame 51b (an example of a seat surface support part) which bridges the inner periphery sides of the first frame 51a in the front-rear direction to support a central portion in the right-left direction of the seat surface 50a. A pair of right and left recessed portions 58 (an example of an accommodation chamber) which accommodates the portion of the casing 31 of the seat part unit 10 is formed between the first frame 51a and the second frame 51b in the right-left direction of the frame 51. The recessed portion 58 is recessed downward.

The first frame 51a and the second frame 51b receive the weight of a person seated on the seat surface 50a. The weight of the person seated on the seat surface 50a is not applied to the casing 31, the drive part 3 (refer to FIG. 2 and the like) in the interior, and the like. Further, since the pair of right and left seat part units 10 is provided in the seat part 50 and the drive part 3 of each of the seat part units 10 has the independent motor 35 (refer to FIG. 2 and the like), it is possible to reduce a load which is applied to the motor 35 by the weight of the person seated on the seat surface 50a. Further, it becomes possible to downsize the motor 35.

Since each of the drive parts 3 of the seat part units 10 has the independent motor 35, the pair of seat part units 10 can perform treatment asynchronously with each other. Further, the pair of seat part units 10 can operate independently and perform independent treatment. In this way, by intensively treating one side of the body of a person by driving only one of the pair of seat part units 10, or by changing a balance between driving times or the timings of driving of the treatment units, it becomes possible to perform treatment according to the level of tiredness of the body of a person or a wish of the person.

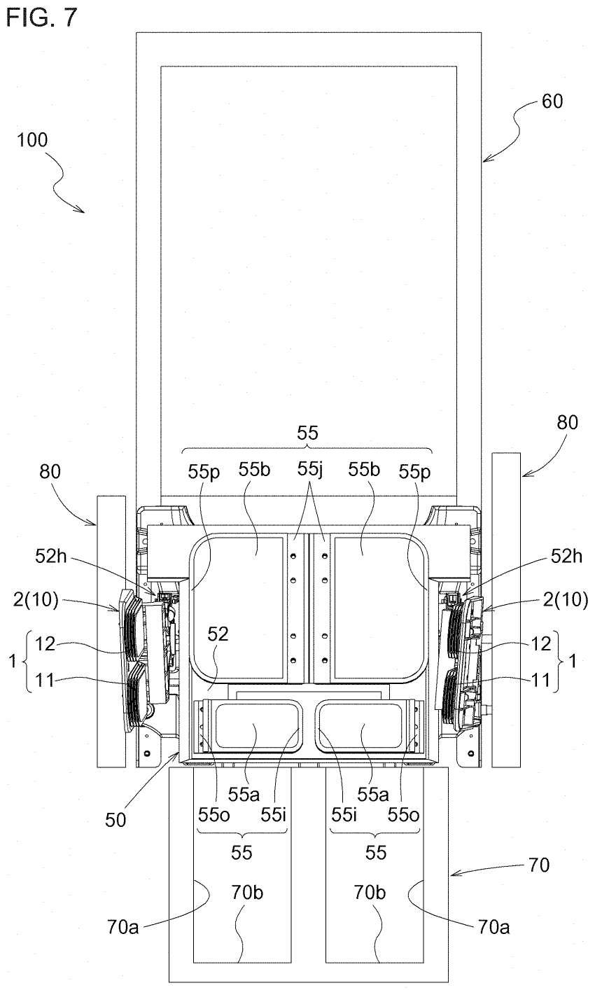

As shown in FIGS. 7 and 8, the seat part sheet 52 is a portion serving as a seat placed on the first frame 51a and the second frame 51b (refer to FIG. 8). The outer surface of the seat part sheet 52 is the seat surface 50a. A pair of gaps 52h penetrating the seat part sheet 52 in the up-down direction is formed on the right and left side surfaces of the seat part sheet 52. The transmission plate 25 of the treatment part 2 of the seat part unit 10 is inserted into the gap 52h. Then, the back plate 21 and the four-finger part 1 supported on the transmission plate 25 are disposed further on the upper side than the seat part sheet 52. In this way, the four-finger part 1 is disposed at a position suitable for treating a part on the outer side of each of the buttock and the thigh of a person seated on the seat surface 50a.

As shown in FIG. 7, the seat surface lifting parts 55 are at least a pair of right and left treatment units placed on the seat part sheet 52. The right and left seat surface lifting parts 55 are plane-symmetrical to each other, and therefore, in the following, the left seat surface lifting part 55 will be described. Since the right seat surface lifting part 55 is plane-symmetrical to the left seat surface lifting part 55, description thereof is omitted.

The seat surface lifting part 55 has cells 55a and 55b (each is an example of a lifting cell) which are expansion and contraction bags placed on the seat part sheet 52. The cells 55a and 55b are disposed further on the inner side in the right-left direction than the gap 52h of the seat part sheet 52, that is, the four-finger part 1 of the seat part unit 10. The cell 55a is disposed in front of the cell 55b. The front end of the cell 55a is disposed further on the front side than the most front end in the oscillation range of the treatment part 2. The rear end of the cell 55b is disposed further on the rear side than the rearmost end in the oscillation range of the treatment part 2.

The cell 55a is a bag having a bellows, in which the fold of the bellows is provided in the direction (such as the right-left direction) along the surface of the seat part sheet 52 and the bag expands and contracts in the direction (the direction along the up-down direction) intersecting the seat surface 50a if a fluid is supplied from a supply and discharge port (not shown) to the bag. The four-finger part 1 of the seat part unit 10 is a treatment element corresponding to the four fingers of a person to be treated, whereas the cell 55a is a treatment element corresponding to the thumb of the person.

An end portion 55o (an example of a fixed end portion) on the outer side (the left side) of the cell 55a is restricted in expansion in the direction intersecting with the seat surface 50a. An end portion 55i (an example of a lifting end portion) on the inner side (the right side) of the cell 55a is not restricted in expansion in the direction intersecting with the seat surface 50a. The portion further on the right side (the inner side) than the end portion 55o of the cell 55a expands and contracts in the direction intersecting the seat surface 50a. In this way, treatment is performed with the thigh or the buttock of a person interposed between the four-finger part 1 of the seat part unit 10 and the cell 55a.

The cell 55b is a bag having a bellows, in which the fold of the bellows is provided in the direction (such as the right-left direction) along the surface of the seat part sheet 52 and the bag expands and contracts in the direction (the direction along the up-down direction) intersecting the seat surface 50a if a fluid is supplied from a supply and discharge port (not shown) to the bag.

An end portion 55j on the inner side (the right side) of the cell 55b is restricted in expansion in the direction intersecting with the seat surface 50a. An end portion 55p on the outer side (the left side) of the cell 55b is not restricted in expansion in the direction intersecting with the seat surface 50a. The portion further on the left side (the outer side) than the end portion 55j of the cell 55b expands and contracts in the direction intersecting the seat surface 50a. In this way, treatment is performed with the buttocks of a person interposed between the pair of right and left cells 55b.

As shown in FIG. 8, the second frame 51b is formed to be upwardly convex between the pair of right and left recessed portions 58. A recessed portion 56 which is recessed upward is formed on the lower side of the second frame 51b. An accommodation space S is formed between the second frame 51b and the recessed portion 56.

There is a case where a part of a drive unit composed of a motor or a shaft for reclining the backrest part 60 is accommodated in the recessed portion 56. If the drive unit or the like of the backrest part 60 is accommodated in the recessed portion 56, the seat part 50 can be formed to be compact in the up-down direction.

An electromagnetic valve unit 19 which controls the supply and discharge of air to and from the cells 11, 12, 55a, and 55b is accommodated in the accommodation space S. An electromagnetic valve is accommodated in the accommodation space S, whereby the seat part 50 can be formed to be compact in the up-down direction.

The disposition of each constituent element in the seat part 50 is complemented. In the seat part 50, the treatment part 2 of the seat part unit 10, the cell 55a, and the second frame 51b are disposed in order from the left armrest part 80 toward the right. Similarly, the seat part unit 10, the cell 55a of the seat surface lifting part 55, and the second frame 51b are disposed in order from the right armrest part 80 toward the left. The second frame 51b and the recessed portion 56 are disposed between the pair of right and left recessed portions 58.

### Regarding Treatment by Seat Part Unit and Seat Surface Lifting Part

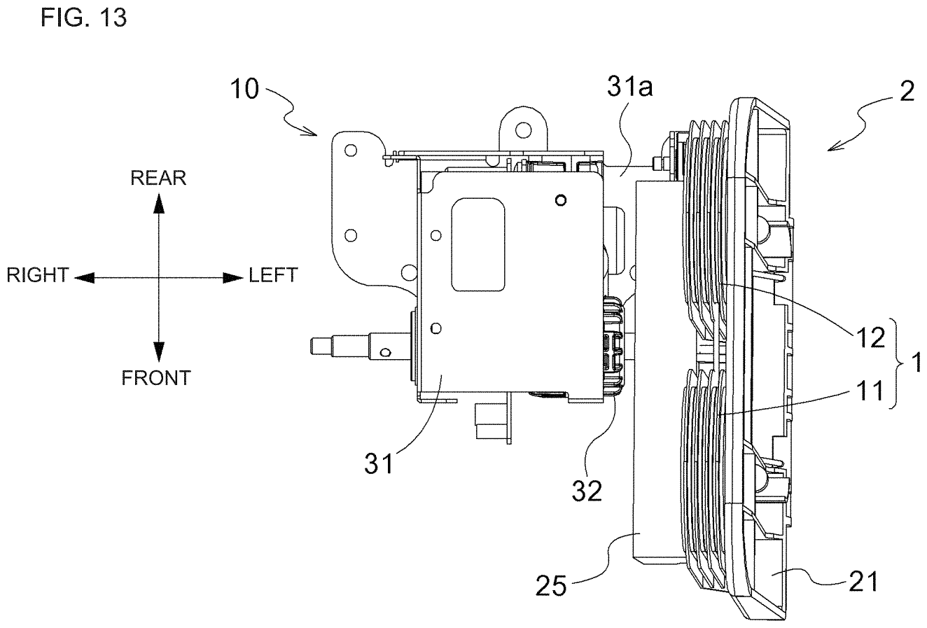

The treatment part 2 oscillates with the oscillation of the cam 4, as shown in the front views of FIGS. 9 to 12 and the top views of FIGS. 13 to 16. FIGS. 9 to 12 are front views of the seat part unit 10. FIGS. 13 to 16 are top views of the seat part unit 10. In a case where the vertex 41t is located at the uppermost position (hereinafter referred to as a first state), the treatment part 2 comes to a position near to the innermost side (the right side). This first state is shown in FIGS. 9 and 13.

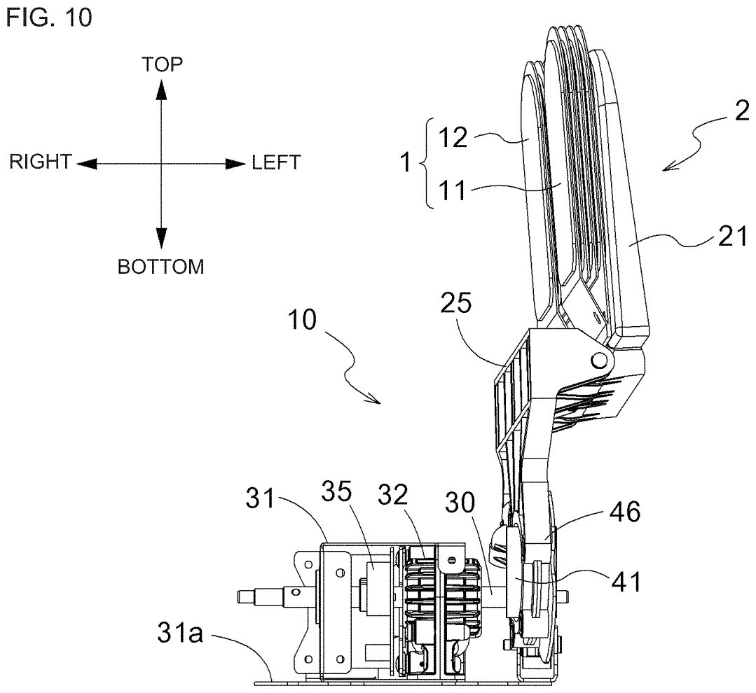

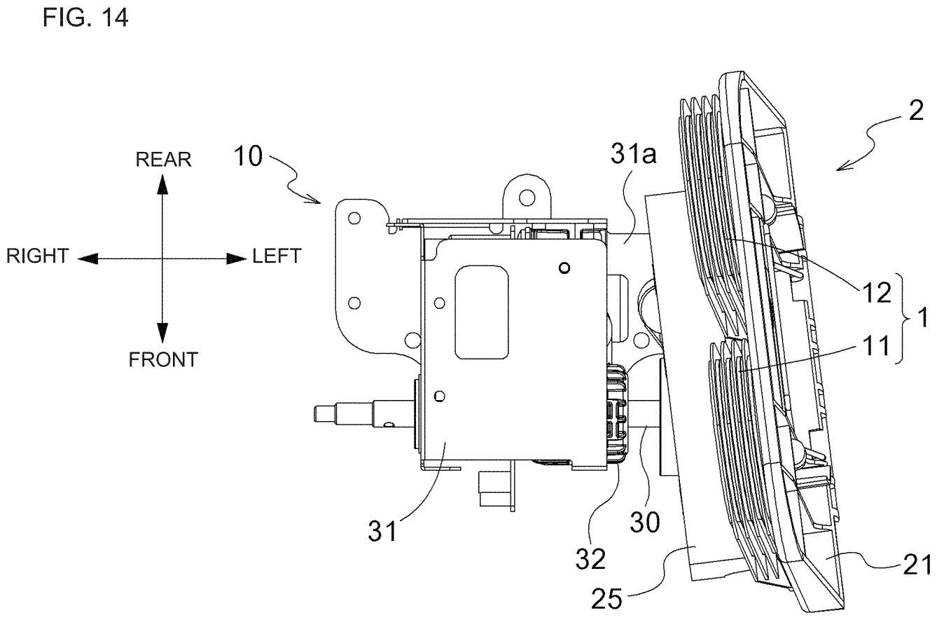

In a case where the vertex 41t is located at the rearmost position (hereinafter referred to as a second state), the treatment part 2 comes to a position near to the uppermost side. In this second state, the treatment part 2 is moved further toward the left side than in the first state. Further, the treatment part 2 is moved further toward the rear side than in the first state. The second state is a state where the treatment part 2 is located at the rearmost end in the oscillation range of the treatment part 2. This second state is shown in FIGS. 10 and 14.

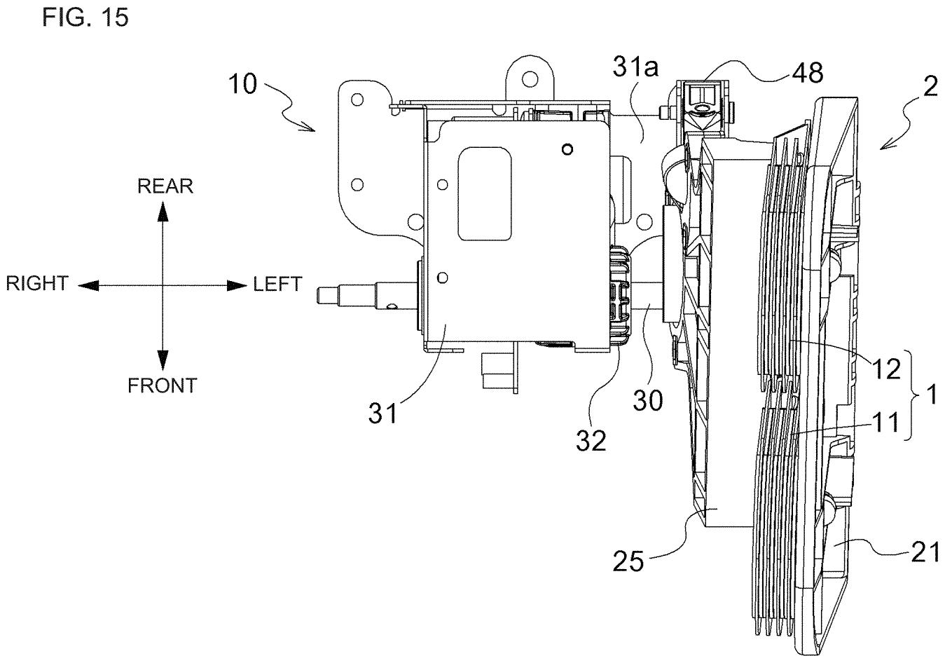

In a case where the vertex 41t is located at the lowermost position (hereinafter referred to as a third state), the treatment part 2 comes to a position neat to the outermost side (the left side). In this third state, the treatment part 2 is at a lower position than in the second state in the up-down direction. The treatment part 2 is moved further toward the front side than in the first and second states. This third state is shown in FIGS. 11 and 15.

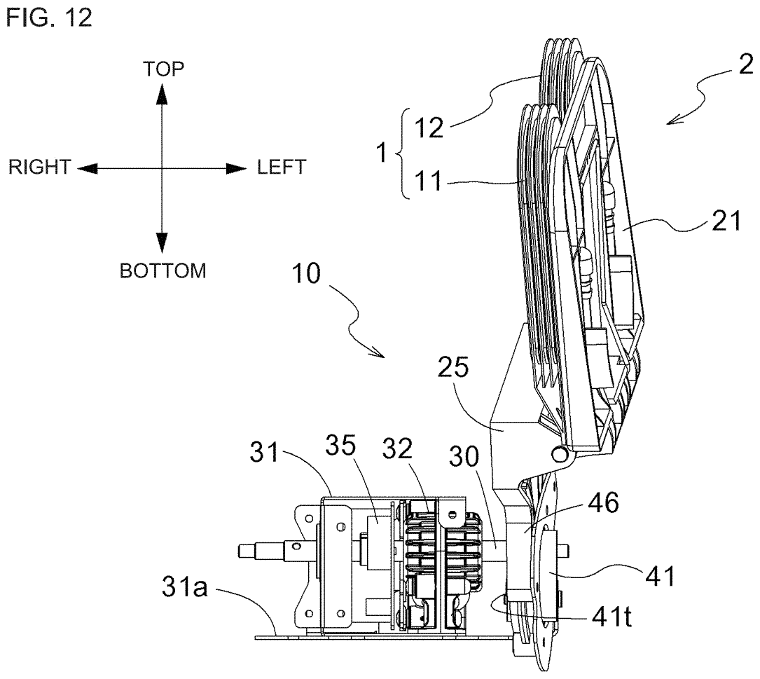

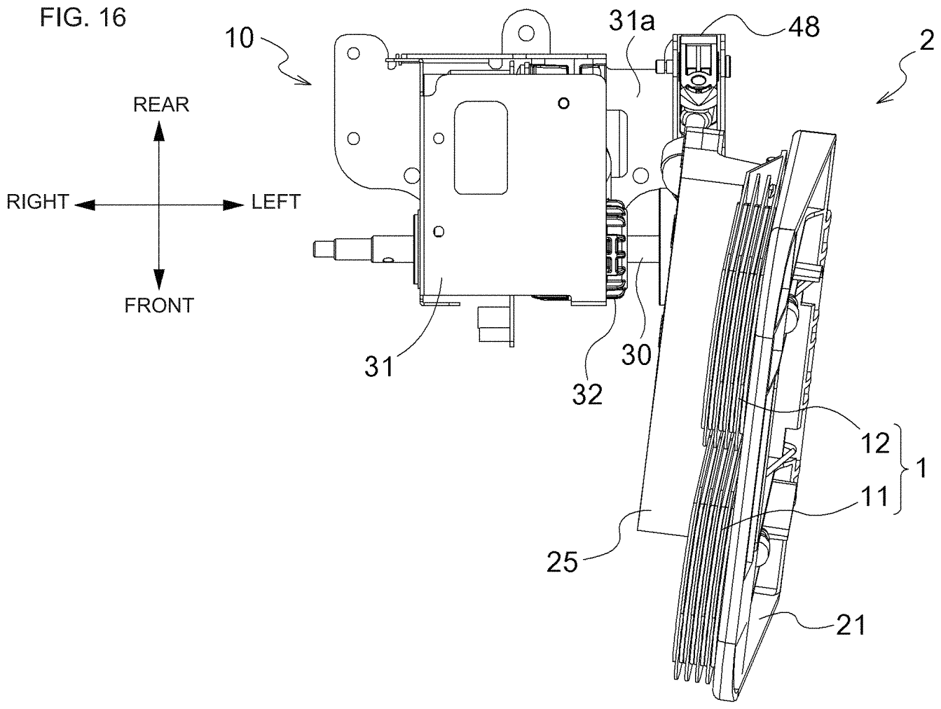

In a case where the vertex 41t is located at the most front position (hereinafter referred to as a fourth state), the treatment part 2 comes to a position near to the lowermost side. In this fourth state, the treatment part 2 is moved further toward the right side than in the third state. In the fourth state, compared to the first state, the treatment part 2 is at a low position in the up-down direction and is moving to the right side. In the fourth state, the treatment part 2 is moved further toward the front side than in the third state. The fourth state is a state where the treatment part 2 is located at the most front end in the oscillation range of the treatment part 2. This fourth state is shown in FIGS. 12 and 16.

The treatment part 2 treats the body of a person by expanding and contracting the cells 11 and 12 while sequentially oscillating from the first state to the fourth state. At this time, due to the oscillation movement of the treatment part 2, the back plate 21 performs a gripping motion and a twisting motion imitating the movements of the wrist and the elbow of a person corresponding to the palm and the back of the hand of the person, whereby treatment is performed. In addition, flexible treatment is realized in which a snap of the wrist of a treatment person is reproduced with the inward pressing action by the biasing force of the elastic member described above. Further, the four-finger part 1 performs treatment by imitating a movement corresponding to a gripping motion by the four fingers of a person by the expansion and contraction operations of the cells 11 and 12.

As described above, it is possible to provide a treatment unit and a massage machine, which realize treatment with a twisting motion added thereto.

### OTHER EMBODIMENTS

(1) In the embodiment described above, a case where the seat part unit 10 is provided at the seat part 50 of the massage machine 100 has been illustrated and described. However, the seat part unit 10 is not limited to the case of being provided at the seat part 50 and can also be provided in the backrest part 60 or the footrest 70 with the same structure as that in the seat part unit 10 to treat the back portion or the waist portion of a person or treat the legs or the feet of a person.

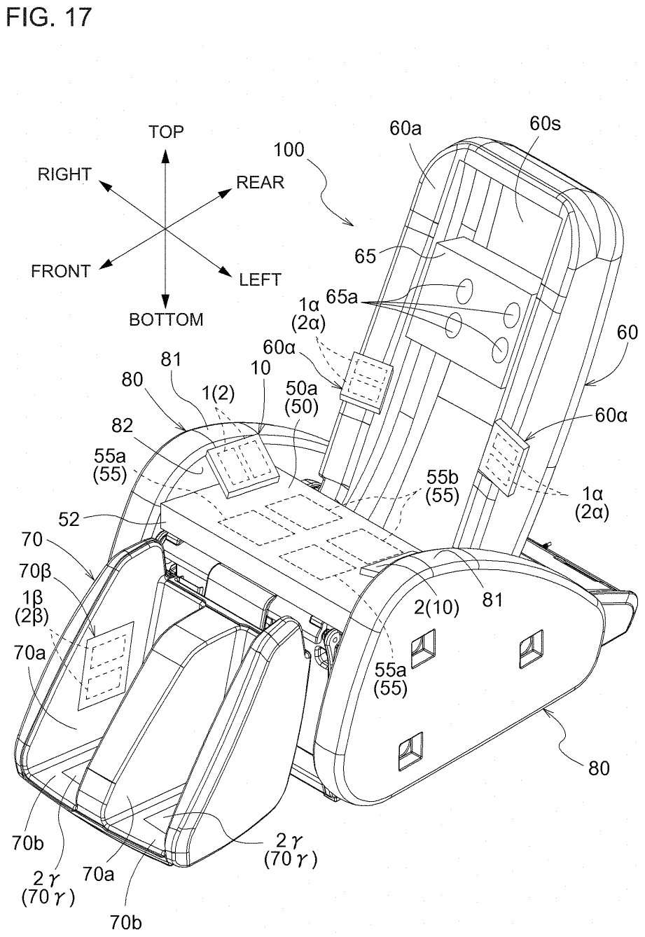

(2) In the embodiment described above, a case where the massage machine 100 has the seat part unit 10, which is an example of a treatment unit, provided at the seat part 50, has been described. However, the massage machine 100 may have, instead of the seat part unit 10 of the seat part 50 or in addition to the seat part unit 10 of the seat part 50, a treatment unit provided at the backrest part 60 as a back part unit 60α to treat the back portion or the waist portion of a person, as shown in FIG. 17.

In this case, treatment parts 2α of the back part units 60α corresponding to the treatment parts 2 of the seat part units 10 are disposed on the right and left sides of the backrest surface 60a. At this time, the treatment parts 2α may be disposed in a pair on the outer side in the right-left direction of the massaging ball unit 65. At this time, a four-finger part 1α of the back part unit 60α corresponding to the four-finger part 1 of the seat part unit 10 is installed to face inward. It is favorable if a casing (not shown) of the back part unit 60α corresponding to the casing 31 of the seat part unit 10 is disposed in an accommodation chamber 60s (refer to FIG. 1) formed such that the back side of the backrest surface 60a, for example, the backrest surface 60a of the backrest part 60 is recessed rearward.

(3) In the embodiment described above, a case where the massage machine 100 has the seat part unit 10, which is an example of a treatment unit, provided at the seat part 50, has been described. However, the massage machine 100 may have, instead of the seat part unit 10 of the seat part 50 or in addition to the seat part unit 10 of the seat part 50, a treatment unit provided in the portion of the groove portion 70a of the footrest 70 as a leg part unit 70β to treat the leg such as the calf of a person, as shown in FIG. 17.

In this case, treatment parts 2β of the leg part units 70β corresponding to the treatment parts 2 of the seat part units 10 are disposed on the right and left side surfaces (sides) of the pair of right and left groove portions 70a. For example, the treatment parts 2β are disposed on the left side surface of the left groove portion 70a and the right side surface of the right groove portion 70a. At this time, a four-finger part 1β of the leg part unit 70β corresponding to the four-finger part 1 of the seat part unit 10 is installed to face the inner side in the right-left direction. It is favorable if a casing (not shown) of the leg part unit 70β corresponding to the casing 31 of the seat part unit 10 is disposed, for example, on the back surface side of the groove portion 70a, for example, in the interior of the footrest 70.

(4) In the embodiment described above, a case where the massage machine 100 has the seat part unit 10, which is an example of a treatment unit, provided at the seat part 50, has been described. However, the massage machine 100 may have, instead of the seat part unit 10 of the seat part 50 or in addition to the seat part unit 10 of the seat part 50, a treatment unit provided at the footboard portion 70b of the footrest 70 as a foot part unit 70γ to treat the foot (for example, a side portion of the foot) of a person, as shown in FIG. 17.

In this case, treatment parts 2γ of the foot part units 70γ corresponding to the treatment parts 2 of the seat part units 10 are disposed on the right and left side surfaces of the pair of right and left footboard portions 70b. For example, the treatment parts 2γ are disposed on the left side surface of the left footboard portion 70b and the right side surface of the right footboard portion 70b. At this time, a four-finger part (not shown) of the foot part unit 70γ corresponding to the four-finger part 1 of the seat part unit 10 is installed to face the inner side in the right-left direction. It is favorable if a casing (not shown) of the foot part unit 70γ corresponding to the casing 31 of the seat part unit 10 is disposed, for example, on the lower side (the back surface side) of the footboard portion 70b.

The configurations disclosed in the above embodiments (including the other embodiments, hereinafter, the same applies) can be applied in combination with the configurations disclosed in other embodiments, as long as no contradiction arises, and further, the embodiments disclosed in this specification are exemplification, and the embodiments of the present invention are not limited thereto and can be appropriately modified within a scope which does not depart from the object of the present invention.

The present invention can be applied to a treatment unit and a massage machine, which realize treatment with a twisting motion added thereto.

Hereinbefore, the present invention has been described with reference to the embodiments, but the present invention is not limited thereto. It is obvious to those skilled in the art that various modifications, replacements, combinations and the like may be made, for example. It should be understood that the invention is not limited to the above-described embodiment, but may be modified into various forms on the basis of the spirit of the invention. Additionally, the modifications are included in the scope of the invention.

The contents of Japanese Application No. 2018-137955 filed on Jul. 23, 2018, including the specification, the claims and the drawings, are incorporated herein by reference in their entirety.

What is claimed is:

1. A treatment unit comprising:
a treatment element configured to press a person to be treated;
a treatment part that includes the treatment element;
an output shaft that drives the treatment part;
a drive part configured to rotate the output shaft; and
a swash plate eccentric cam that rotates integrally with the output shaft,
wherein the treatment part oscillates in a direction along a direction of an axis of rotation of the output shaft and a direction intersecting the direction of the axis without rotating along with rotation of the swash plate eccentric cam.

2. The treatment unit according to claim 1, wherein the treatment part includes a support part that includes a plate surface, the support part supports the treatment element, and
the treatment element includes an air cell that expands and contracts at least in a direction intersecting the plate surface according to supply and discharge of a fluid, the air cell is supported on the plate surface.

3. The treatment unit according to claim 2, wherein the treatment unit comprises treatment elements, each of the treatment elements individually includes the air cell,
the air cell includes an independent supply and discharge port for the fluid, and
the air cell can independently expand and contract.

4. A massage machine comprising:
a pair of the treatment units according to claim 1,
wherein the pair of the treatment units are disposed symmetrically in right and left so as to be suitable for treatment on right and left sides of a body of the person to be treated.

5. The massage machine according to claim 4, further comprising:
a seat part that includes a seat surface for the person to be treated,
wherein the seat part comprises an accommodation chamber provided below the seat surface,
the drive part of each of the pair of treatment units is accommodated in the accommodation chamber, and
the treatment element of each of the pair of treatment units is disposed at a position where treatment can be performed on at least a part on an outer side of a buttock and a thigh of the person to be treated seated on the seat part on an upper side of the seat surface.

6. The massage machine according to claim 5, wherein the seat part includes a seat surface lifting part configured to lift and lower a part of the seat surface provided between the pair of treatment units, and
wherein the seat part includes a seat surface support part that supports the seat surface provided between the pair of treatment units at a lower side.

7. The massage machine according to claim 6, wherein the seat surface lifting part includes at least a pair of right and left lifting cells, each of the lifting cells includes a lifting end portion which is lifted and lowered in a direction intersecting the seat surface, and a fixed end portion, and
the lifting end portions are disposed on right and left inner sides of the pair of right and left lifting cells.

8. The massage machine according to claim 4, further comprising:
a backrest part that includes a backrest surface suitable for putting a back of the person to be treated thereon,
wherein the treatment element is configured to treat a back portion or a waist portion of the person to be treated on a front side of the backrest surface.

9. The massage machine according to claim 4, further comprising:
a footrest having a groove portion suitable for putting a lower thigh of the person to be treated therein,
wherein the treatment element is configured to treat a calf of the person to be treated from a side of the groove portion.

10. The massage machine according to claim 4, further comprising:
a footrest that includes a footboard portion suitable for placing a foot of the person to be treated thereon,
wherein the treatment element is configured to treat a side portion of the foot of the person to be treated on an upper side of the footboard portion.

11. The massage machine according to claim 4,
wherein the drive part of each of the pair of treatment units is operable asynchronously.

12. The massage machine according to claim 4,
wherein the drive part of each of the pair of treatment units includes an independent motor.
